(19) United States
(12) Patent Application Publication
(10) Pub. No.: US 2002/0084945 A1
(43) Pub. Date: Jul. 4, 2002

(54) Low multipath interference microstrip array and method

(76) Inventor: Donald A. Huebner, Larkspur, CO (US)

Correspondence Address: ANCEL W. LEWIS, JR., 425 WEST MULBERRY, SUITE 101, FORT COLLINS, CO, 80521, US

(21) Appl. No.: 10/040,101

(22) Filed: Jan. 4, 2002

Related U.S. Application Data
(60) Provisional application No. 60/259,708, filed on Jan. 4, 2001.

(51) Int. Cl. H01Q 21/00; H01Q 1/38

(52) U.S. Cl. 343/853; 343/700 MS; 342/375

(57) ABSTRACT

A microstrip array antenna has rows of radiating elements with the rows phase shifted according to a phase distribution. The distribution is anti-symmetrical and generally linear in magnitude over most of the array length, decreasing back to zero as the array edges are approached. The top and bottom rows are not phase shifted. The rows are phase shifted by lengthening the connecting lines to the radiating elements. Shifting the phase of the rows according to the phase distribution reduces only the lower, ground directed sidelobes of the antenna radiation pattern.

This application claims the benefit under 35 U.S.C. § 119(e) of the U.S. provisional patent application No. 60/259,708 filed Jan. 4, 2001.

### TECHNICAL FIELD

The present invention relates to antennas and more particularly to a microstrip array antenna with low multipath interference and a method of reducing array multipath interference.

### BACKGROUND ART

Antennas for ground-based point-to-point communications are typically mounted with their main beam pointed toward the horizon. The sidelobes below the main beam of such an antenna can reflect off the ground and create unwanted multipath signals. FIG. 1 shows a prior known linear microstrip array 10 having a plurality of uniformly spaced, linearly aligned radiating elements 11 and a feed network 12 with an input 13. The feed network 12 is a corporate feed network, which is defined as a feed network in which the electrical distance from the input 13 to each radiating element 11 is the same. FIG. 2 shows a graph of the uniform phase distribution of the array 10 of FIG. 1 and FIG. 3 shows a graph of the elevation plane radiation pattern of the array 10 of FIG. 1. The horizon corresponds to the 0 degree angle, with angles below the horizon being positive. The radiation pattern of FIG. 3 is symmetrical, with the peak sidelobe level being about 14 dB below the main beam peak.

Two main techniques have previously been used to lower the ground-directed sidelobes. The first is to apply an amplitude taper to the array element voltages. An amplitude taper lowers all of the sidelobes in the radiation patterns of both linear and planar arrays. Amplitude tapers are implemented by exciting the elements near the array center with the highest voltage, and gradually reducing this voltage in a systematic way as one progresses to the array edges. Standard amplitude taper distributions include (inverse) parabolic, cosine, Taylor, and Chebyshev.

A second method, which only applies to planar arrays, involves choosing the array shape to achieve an equivalent amplitude taper. Typical examples of this method include circular and diamond-shaped arrays. These two techniques can be combined to obtain even lower sidelobe levels. However, both methods reduce sidelobes symmetrically on both sides of the antenna main beam, even though there is no advantage in lowering sidelobes that point above the horizon. Both techniques broaden the main beam, and use of an amplitude taper also reduces the antenna gain.

“Design of line-source antennas for narrow beamwidth and asymmetric low side lobes”, R. S. Elliot, Apr. 9, 1973, Hughes Aircraft Company TIC 2127.74/29 discloses an antenna array pattern with specified asymmetric sidelobes with a symmetric amplitude taper and an anti-symmetric phase distribution.

### DISCLOSURE OF THE INVENTION

A low multipath interference microstrip array disclosed includes a plurality of rows of radiating elements and a feed network having a plurality of feed lines connected to an input at one end and to the radiating elements at the opposite end. Each element in a row has the same phase and the rows are phase shifted relative to each other according to a selected anti-symmetrical distribution by adjusting the length of the feed lines.

### BRIEF DESCRIPTION OF THE DRAWINGS

Details of this invention are described in connection with the accompanying drawings that bear similar reference numerals in which:

FIG. 1 is a diagrammatic view of a prior known linear microstrip array.

FIG. 2 is a graph of the phase distribution of the array of FIG. 1.

FIG. 3 is a graph of the elevation plane radiation distribution of the array of FIG. 1.

FIG. 4 is a diagrammatic view of a microstrip array embodying features of the present invention.

FIG. 5 is a graph of the phase distribution of the array of FIG. 4.

FIG. 6 is a graph of the elevation plane radiation distribution of the array of FIG. 4.

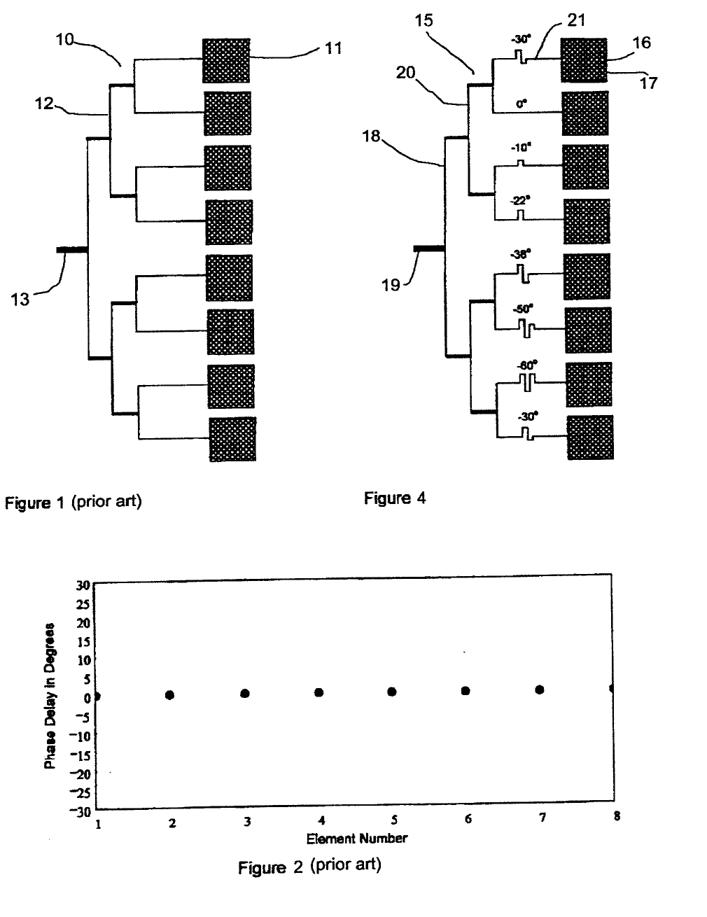

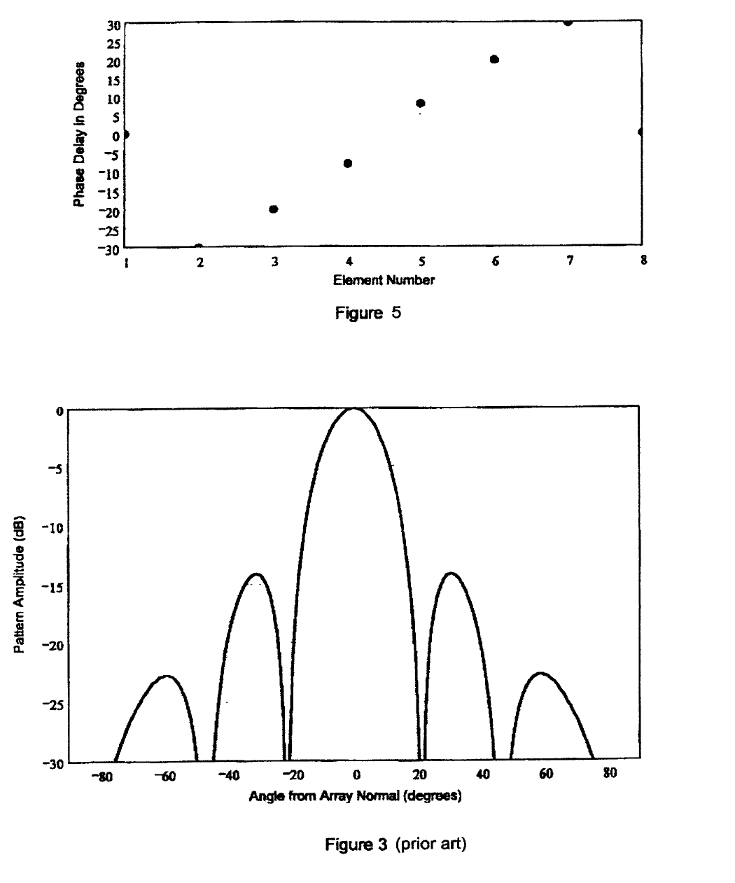

### DETAILED DESCRIPTION OF THE INVENTION

Referring now to FIG. 4, a microstrip array 15 embodying features of the present invention includes a plurality of rows 16 of radiating elements 17 and a feed network 18. For illustrative purposes the array 15 is shown as a linear array with each row 16 having one element 17. The array 15 may also be a planar array, with the rows 16 having more than one element 17, as described hereinafter.

The feed network 18 has an input 19, a plurality of conductive branching feed lines 20 connected to the input and a plurality of conductive connecting lines 21 that each connect from a feed line 20 to an element 17. The feed lines 20 are sized to each have the same length from the input 19 to a connecting line 21. The connecting lines 21 have the same length for each element 17 in a row 16. The length of the connecting lines 21 varies from row 16 to row 16 and is selected to shift the phase of the signals radiating from the elements 17 of the rows 16 according to a selected phase distribution. The connecting lines 21, in combination with the feed lines 20 and input 19, provide a means for shifting the phase of each row according to the phase distribution.

FIG. 5 shows an exemplary phase distribution for the array 15 with eight rows 16. The first row is shifted 0 degrees, the second row is shifted −30 degrees, the third row is shifted −20 degrees, the fourth row is shifted −8 degrees, the fifth row is shifted 8 degrees, the sixth row is shifted 20 degrees, the seventh row is shifted 30 degrees and the eighth row is shifted 0 degrees. The maximum amount of phase in the distribution is not large, +/−30 degrees in the current example.

It is desirable to implement the phase distribution by adding line lengths alone. Adding line lengths creates a negative phase shift. The distribution shown in FIG. 5 is applied by adding a −30 degree shift to each row so that the phase shift for each row is equal to or less than zero and can therefore be accomplished by adding line length. Referring again to FIG. 4, starting with the first row at the bottom, the first row is shifted −30 degrees, the second row is shifted −60 degrees, the third row is shifted −50 degrees, the fourth row is shifted −38 degrees, the fifth row is shifted −22 degrees, the sixth row is shifted −10, the seventh row is shifted 0 degrees and the eighth row is shifted −30 degrees. The −30 degree constant phase offset applied to all of the antenna rows 16 has no effect on the radiation pattern. The additional line lengths have been incorporated as meander line sections.

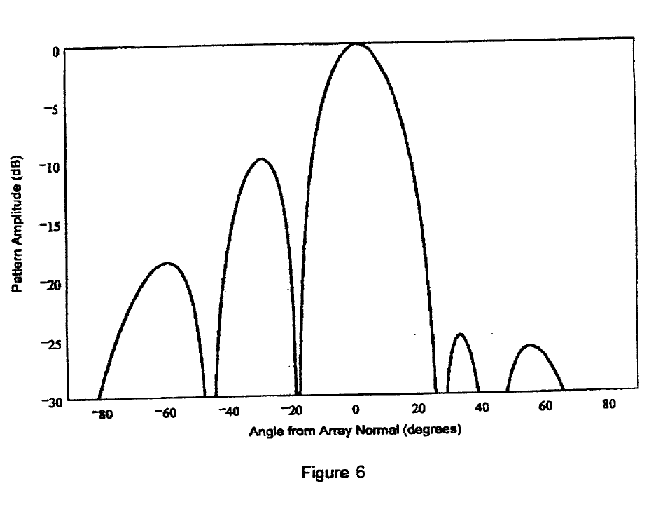

FIG. 6 shows the resulting radiation pattern for the array of FIG. 4. The horizon corresponds to the 0 degree angle, with angles below the horizon being positive. The sidelobes directed below the horizon are lowered by 11 dB to about −25 dB. At the same time, the sidelobes pointing above the horizon have increased with a peak value of about −10 dB. The peak of the main beam is also observed to have shifted slightly downward in angle. However, this latter effect is minimal and can be readily corrected by mechanically tilting the array slightly upwards.

The anti-symmetrical phase distribution can be used with any printed-circuit linear or planar array antenna to reduce the below-horizon sidelobes. The term anti-symmetrical as used herein means symmetrical about the origin such that f(−x)=−f(x). FIG. 4 shows one element 17 per row 16, however each row 16 could have several elements 17 with the same phase being applied to each element 17 in a row 16. The anti-symmetrical phase distribution can also be used with an array that already utilizes shape or amplitude tapering to further lower the below-horizon sidelobes.

As an example, the anti-symmetrical phase distribution can be used with a diamond shaped planar array. A diamond shaped planar array is commonly used since it creates low sidelobe levels (ideally, about −25 dB) in the vertical plane where ground multipath is of the greatest concern. The addition of the disclosed anti-symmetrical phase distribution will allow the below-horizon sidelobes in the vertical plane to be reduced by at least another 10 dB.

The lower limit to the number of rows 16 of elements 17 the disclosed anti-symmetrical phase distribution can be used with has been found empirically to be six. Fewer than six rows 16 does not provide a phase taper that can adequately simulate the desired phase distribution discussed above. It has also been found that the maximum phase, and therefore line length, will increase with the array size. The disclosed anti-symmetrical phase distribution is generally not suitable for array with more than 64 rows due to the limited available room for the additional line lengths.

The disclosed array of the present invention with the anti-symmetrical phase distribution reduces multipath interference without requiring an amplitude taper or a prescribed array shape. By varying the element phase in an anti-symmetric, non-uniform manner, only the sidelobes in the lower, ground directed angular region will be reduced. The upper sidelobes are correspondingly increased, but the upper sidelobes are pointed towards the sky where multipath reflections normally do not occur. Degradation in main beam beamwidth and antenna gain are also minimized.

The exact phase distribution can be determined empirically or through use of computer optimization. However, the phase distribution will always have the general shape shown in FIG. 6. This distribution is characterized by: (1) anti-symmetry about the array center, (2) increasing in magnitude from zero at the array center in an approximately linear fashion towards the array edges over the majority of the array length until a maximum value is reached, and (3) decreasing from this maximum back to zero as the array edges are approached.

The method of reducing array multipath interference of the present invention includes the steps of providing an array with a plurality of rows of radiating elements and shifting the phase of the rows relative other according to a selected phase distribution. The distribution has the characteristics set forth above. The phase is shifted by selectively lengthening the connecting lines to the radiating element.

Reversing the antenna orientation utilizing the method of the present invention enhances sidelobes on the ground and reduces radiation into space. This radiation pattern is desirable for cellular and PCS base station antennas.

Although the present invention has been described with a certain degree of particularity, it is understood that the present disclosure has been made by way of example and that changes in details of structure may be made without departing from the spirit thereof.

What is claimed is:

1. A low multipath interference microstrip array comprising:
a plurality of rows of radiating elements including a top row and a bottom row opposite said top row, there being an array center intermediate said top and bottom rows, each said row having at least one said element, and
a feed network connected to said elements and including means for shifting the phase of a signal radiating from said elements of each said row according to a selected phase distribution, said distribution being characterized by each element in a said row being phase shifted equally, said rows being phase shifted anti-symmetrically about said array center, said rows being phase shifted increasingly in magnitude from zero at said array center in a generally linear fashion outwardly to a maximum value near said top and bottom rows, then said rows being phase shifted decreasingly from said maximum value outwardly to said top and bottom rows with said top and bottom rows having zero phase shift relative to said array center.

2. The array as set forth in claim 1 wherein said feed network includes an input, a plurality of feed lines and a plurality of connecting lines, said feed lines being connected to said input and each said feed line being equal in length to each other feed line, each said element being connected to one said connecting line and each said connecting line being connected to one said feed line, and each said row having a selected length for said connecting lines to shift the phase of said radiating elements of said row according to said phase distribution.

3. The array as set forth in claim 2 wherein said plurality of rows includes a maximum row near said top row, said maximum row being characterized by the greatest positive phase shift, and
said selected length for said maximum row is shortest and said selected lengths for said rows other than said maximum row are each longer to provide a negative phase shift according to said phase distribution for each said row other than said maximum row relative to said maximum row.

4. The array as set forth in claim 1 wherein said rows above said array center, other than said top row, are phase shifted positively relative to said array center, and said rows below said array center, other than said bottom row, are phase shifted negatively relative to said array center.

5. A low multipath interference microstrip array comprising:
a plurality of rows of radiating elements including a top row and a bottom row opposite said top row, there being an array center intermediate said top and bottom rows, each said row having at least one said element, and
a feed network connected to said elements, and including an input, a plurality of feed lines connected to said input, and a plurality of connecting lines each connected to one said feed line and one said element, each said feed line being equal in length to each other feed line, and said connecting lines having selected lengths that are selected to phase shift a signal radiating from said elements of each said row according to a selected phase distribution, said distribution being characterized by each element in a said row being phase shifted equally, said rows being phase shifted anti-symmetrically about said array center, said rows being phase shifted increasingly in magnitude from zero at said array center in a generally linear fashion outwardly to a maximum value near said top and bottom rows, then said rows being phase shifted decreasingly from said maximum value outwardly to said top and bottom rows with said top and bottom rows having zero phase shift relative to said array center.

6. A method of reducing array multipath interference comprising the steps of:
providing a plurality of rows of radiating elements including a top row and a bottom row opposite said top row, there being an array center intermediate said top and bottom rows, each said row having at least one said element, and
shifting the phase of a signal radiating from said elements of each said row according to a selected phase distribution, said distribution being characterized by each element in a said row being phase shifted equally, said rows being phase shifted anti-symmetrically about said array center, said rows being phase shifted increasingly in magnitude from zero at said array center in a generally linear fashion outwardly to a maximum value near said top and bottom rows, then said rows being phase shifted decreasingly from said maximum value outwardly to said top and bottom rows with said top and bottom rows having zero phase shift relative to said array center.

7. The method as set forth in claim 6 wherein said step of shifting includes:
providing an input,
connecting a plurality of equal length feed lines to said input,
connecting a connecting line from each said radiating element to a said feed line, with each said row having a selected length for said connecting lines to shift the phase of said radiating elements of said row according to said phase distribution.

8. The method as set forth in claim 7 wherein said plurality of rows includes a maximum row near said top row, said maximum row being characterized by the greatest positive phase shift, and
said selected length for said maximum row is shortest and said selected lengths for said rows other than said maximum row are each longer to provide a negative phase shift according to said phase distribution for each said row other than said maximum row relative to said maximum row.

9. The method as set forth in claim 6 wherein said step of shifting the phase includes shifting the phase positively in said rows above said array center, other than said top row, relative to said array center, and shifting the phase negatively in said rows below said array center, other than said bottom row, relative to said array center.

10. A method of reducing array multipath interference comprising the steps of:
providing a plurality of rows of radiating elements including a top row and a bottom row opposite said top row, there being an array center intermediate said top and bottom rows, each said row having at least one said element,
providing an input,
connecting a plurality of equal length feed lines to said input,
connecting a connecting line from each said radiating element to a said feed line, with each said row having a selected length for said connecting lines to shift the phase of a signal radiating from said elements of said row according to a selected phase distribution, said distribution being characterized by each element in a said row being phase shifted equally, said rows being phase shifted anti-symmetrically about said array center, said rows being phase shifted increasingly in magnitude from zero at said array center in a generally linear fashion outwardly to a maximum value near said top and bottom rows, then said rows being phase shifted decreasingly from said maximum value outwardly to said top and bottom rows with said top and bottom rows hating zero phase shift relative to said array center.
